(19) United States
(12) Patent Application Publication
(10) Pub. No.: US 2019/0348793 A1
(43) Pub. Date: Nov. 14, 2019

(54) Outlet Incorporating an Outlet Modular Enclosure and a Snap-In / Snap-Out Outlet Unit

(71) Applicant: Astronics Advanced Electronic Systems Corp., Kirkland, WA (US)

(72) Inventor: David Boe, Kirkland, WA (US)

(21) Appl. No.: 16/398,801

(22) Filed: Apr. 30, 2019

Related U.S. Application Data
(60) Provisional application No. 62/668,542, filed on May 8, 2018.

(51) Int. Cl. H01R 13/516; H01R 13/631; H01R 13/627; H01R 13/6581

(52) U.S. Cl. CPC H01R 13/516; H01R 13/6581; H01R 13/6273; H01R 13/631

(57) ABSTRACT

An outlet modular enclosure (OME) is configured to receive a compatible Snap-In/Snap-Out (SISO) outlet unit. The outlet modular enclosure includes an electrically conductive housing with a first aperture sized to receive the outlet unit and a second aperture sized to receive a wire harness. The electrically conductive housing forms at least a portion of a Faraday cage around the outlet unit. The modular unit (MOU) assembly includes the OME and a compatible Snap-In/Snap-Out (SISO) OU with a front side faceplate. The opposing rear side of the SISO is receivable within the first aperture of the OME, while a wire harness adapted to deliver power and data to the OU is received by the second aperture. The wire harness has an electrically conductive shield overbraid at a first end thereof that is electrically connectable to the outlet modular housing.

### CROSS-REFERENCE TO RELATED PATENT APPLICATION

This patent application claims a benefit to the filing date of U.S. Provisional Patent Application Ser. No. 62/668,542 titled, “Outlet Incorporating an Outlet Modular Enclosure and a Snap-In/Snap-Out Outlet Unit,” by Boe, which was filed on May 8, 2018. The disclosure of U.S. 62/668,542 is incorporated by reference herein in its entirety.

### BACKGROUND OF THE DISCLOSURE

Design mitigation for electromagnetic interference (EMI) emissions and susceptibility have historically had a minor effect on the performance of electrical outlet units (OU) located in the cabin of a passenger aircraft. However, with the advent of more advanced onboard control chips and power supplies for USB Type A and Type C receptacles, and with the emergence of universal serial bus (USB) data pass-thru needs, a need for emissions and susceptibility mitigation techniques has become more pronounced. Certification testing for EMI has become increasingly difficult to meet when the outlet is balancing a competing requirement for high speed data pass-through.

When a pre-existing USB Type-A outlet is reconfigured to meet new requirements, such as to add high speed data pass-through, changes are constrained by a desire to minimize qualification testing by relying on similarity claims to pre-existing, qualified, outlet units as much as possible. Meeting USB high speed data pass-through requirements (signal time delay, insertion loss, differential mode impedance, and common mode impedance) challenges pre-existing designs, especially with regard to EMI mitigation. Even minor changes to the design to assure EMI performance (e.g.—adding chokes) has significant negative impact on meeting new data pass-through requirements. Likewise, conductive coatings on the inside of the housing that were implemented as mitigation for EMI effectively removed the unit from possible qualification by similarity claims.

Concessions have also been made to data pass-thru requirements, such as changing to eye-diagram requirements and shortening cable lengths.

Current passenger aircraft cabin OU installation techniques include connecting an external cable harness shield that terminates at a wire harness loop to a mating connector in the passenger seat. The connector is extracted for connection to an OU or to an OU pigtail. During initial installation, or during maintenance activity, the outlet unit along with the wire harness loop must be pulled from the seat. The assembled OU/harness loop is then re-inserted, and the OU clamped to the seat fixture manually. One suspected EMI culprit is a combination of the inability of a low-cost pin and socket connector to adequately pass the external cable harness shield into the OU without exposure, and exposure caused by the opening in the outlet unit housing where the mating connector is mounted.

A Faraday cage is an enclosure used to block electromagnetic fields. The Faraday cage is typically formed by surrounding the installation to be shielded with a continuous covering of a conductive material or a mesh of the conductive material. The Faraday cage operates because an external electrical field causes the electric charges within the cage's conducting material to be distributed so that they cancel the field's effect. This phenomenon is used to protect sensitive electronic equipment from external radio frequency interference. Faraday cages are also used to enclose devices that produce radio frequency interference, such as radio transmitters, to prevent their radio waves from interfering with other nearby equipment.

The performance of an outlet unit in the cabin of a passenger aircraft may be improved by surrounding that outlet unit with a Faraday cage.

### SUMMARY OF THE DISCLOSURE

An outlet modular enclosure (OME) is configured to receive a compatible Snap-In/Snap-Out (SISO) outlet unit. The outlet modular enclosure includes an electrically conductive housing with a first aperture sized to receive the outlet unit and a second aperture sized to receive a wire harness. The electrically conductive housing forms at least a portion of a Faraday cage around the outlet unit. The modular unit (MOU) assembly includes the OME and a compatible Snap-In/Snap-Out (SISO) OU with a front side faceplate. The opposing rear side of the SISO is receivable within the first aperture of the OME, while a wire harness adapted to deliver power and data to the OU is received by the second aperture. The wire harness has an electrically conductive shield overbraid at a first end thereof that is electrically connectable to the outlet modular housing.

### DRAWINGS

FIG. 1 is a schematic that illustrates a USB type A outlet unit as known from the prior art having a data pass-through added thereto.

FIG. 2 is a perspective view of a Snap-In/Snap-Out (SISO) outlet unit.

FIG. 3 is top sectional view of a SISO installation.

FIG. 4 is a side sectional view of the SISO installation.

FIG. 5 illustrates a Faraday Cage formed around the SISO installation.

FIG. 6 illustrates flange mounting options for the SISO installation.

### DETAILED DESCRIPTION

The following acronyms are utilized in this disclosure:
i. AC—Alternating Current
ii. EMI—Electromagnetic Interference
iii. IFE—In-Flight Entertainment [Equipment]
iv. MOU—Modular Outlet Unit
v. OEM—Original Equipment Manufacturer
vi. OME—Outlet Modular Enclosure
vii. OU—Outlet Unit
viii. PED—Passenger Electronic Device
ix. SISO—Snap-In/Snap-Out
x. USB—Universal Serial Bus

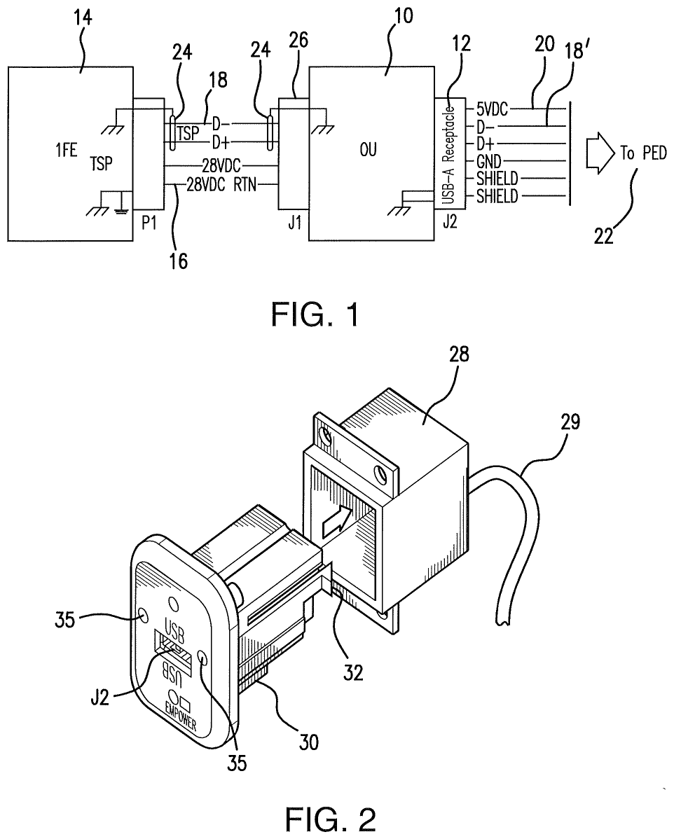

FIG. 1 schematically illustrates an outlet unit 10 having a USB Type A receptacle 12. An in-flight entertainment (IFE) system 14 provides the outlet unit 10 with power 16 and data 18. A stepped-down power 20 and data 18′ are then provided to a passenger's personal electronic device 22 (PED) via the USB Type A receptacle 12. Despite shielding 24, the opening around the connectors 12, 26 on either side of the outlet unit 10 make the outlet unit vulnerable to EMI emissions and susceptibility, resulting in interference with the high-speed data flow. This vulnerability then requires additional EMI mitigation, in-turn further affecting the high-speed USB data design.

As illustrated in FIG. 2, to mitigate EMI, there is installed a mating housing, outlet modular enclosure 28, that is similar in shape to a junction box used in home wiring for containing an AC wall outlet. This OME 28 contains a permanently mounted mating connector for the outlet unit itself, and offers a “snap-in/snap-out” (SISO) capability as part of a standard “Modular Outlet Unit” (MOU) for ease of installation and maintenance, and precludes the need to pull out a wire loop for installation. Furthermore the OME 28 includes a wire harness 29 shield termination inside the outlet modular enclosure 28, effectively turning the enclosure into an extension of the shield; a faraday cage, per se, for the covered portion of the unit, precluding a need for additional circuit design mitigation for EMI. The OME 28 offers installation improvements to seat suppliers and original equipment manufacturers and provides significant improvements to emissions and susceptibility exposure.

FIG. 2 depicts a fixed installation of a conductive Outlet Modular Enclosure (OME) 28 with a “Snap-In/Snap-Out” (SISO) outlet unit 30. This concept results in a standard OME 28 that accepts variations of outlet unit part numbers, or part number families. In this manner the OME can be permanently installed by a seat integrator or OEM, but still allow for a selection of future upgrade or change options. Approaching this as a standard, fixed installation may mean that a “standard” harness design is necessary as well, which would provision for variations of outlet units. A design standard would create dimensional boundaries for latch positioning, mating connector positioning, mating connector selection and pinout definition, and alignment pin positioning.

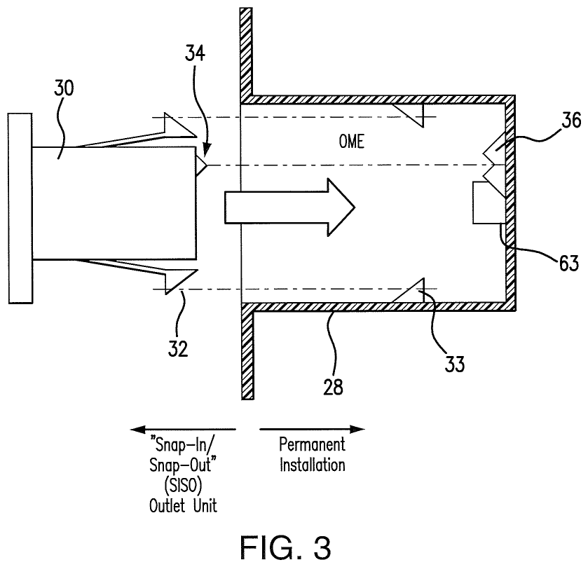

FIG. 3 depicts a top view of the SISO outlet unit 30 and shows a hook latch 32 design that engages a latch flange 33 in the outlet modular enclosure 28. Dimensions for size and positioning are defined by the mechanical design. The SISO modular outlet unit has latch release ports 35 for tool access (see FIG. 2). These latch release ports 35 replace conventional clamp screw holes. The latch 32 may be accessed through the latch release ports by two small gauge, long-handled, Allen wrenches, or an equivalent tool. A specially designed extraction tool could be designed to engage both latches 32 simultaneously to extract the MOU. This extraction tool allows both ports to be accessed with the same tool at the same time for MOU extraction.

Referring back to FIG. 3, it is preferred that an alignment pin 34 (or pins) be provisioned on the SISO 30 modular outlet unit for mating with a companion receptacle 36, or “cone” in the fixed OME 28 installation. The number, placement, and dimensions for a standard alignment mechanism are defined by detailed mechanical design.

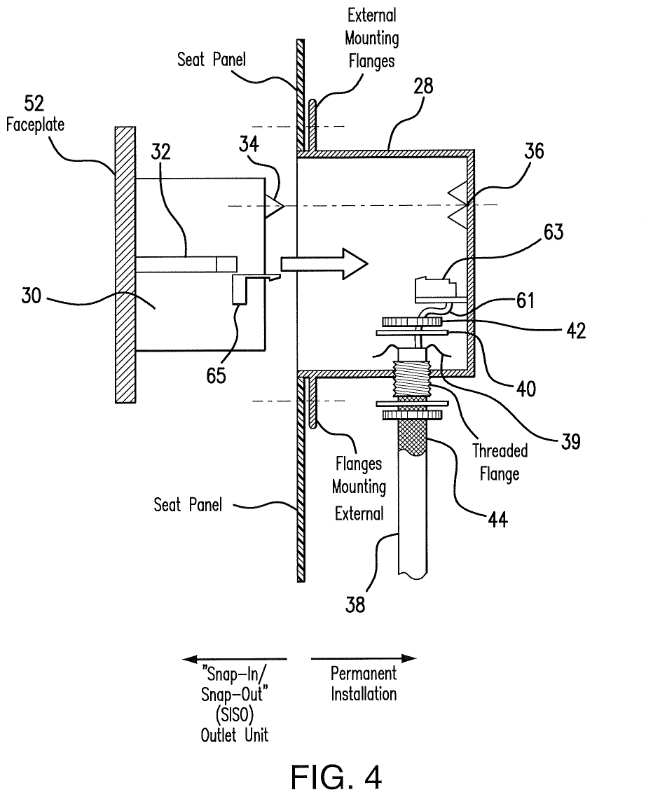

FIG. 4 provides a more detailed view of an installation embodiment. A standard type of connector is shown. A 7 amp capacity is required to accommodate potentially higher ratings necessitated by future applications (e.g.—USB Type C). But detailed mechanical and electrical design will finalize the necessary connector definition.

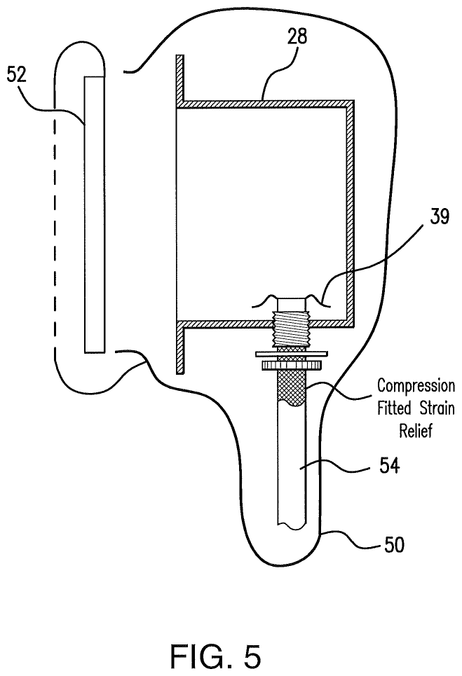

A feature of this concept is electrically extending 39 the aircraft wire harness shield 38 into the OME 28. This wire harness shield 38 is formed from an electrically conductive material such as nickel or silver plated copper. The OME 28 effectively becomes an extension of this shield 38 forming a partial “faraday cage”. FIG. 5 depicts electrically bonding a wire harness shield overbraid 38 to the OME 28 via a conductive washer 40 and nut 42 system as illustrated in FIG. 4. This system would likely require a harness strain relief 44 external to the OME to be incorporated (perhaps silicon or polymer). This faraday cage 50 (FIG. 5) is further enhanced via the use of a conductive faceplate 52 electrically bonded to the OME 28 when the SISO 30 modular outlet unit is “snapped in”. One difficulty is the lack of visibility into the other end of the wire harness 54, which is often not controlled by outlet unit supplier. To maximize the shielding benefit, the wire harness shield must be properly grounded at the other end 54.

Power and data lines 61 are only exposed within the Faraday cage and are electrically interconnected to a fixed mating connector 63 that engages the outlet unit connector 65 when the SISO modular outlet unit is snapped into place. The fixed mating connector precludes a need for wire harness loops to accommodate a family of SISO Outlet Units.

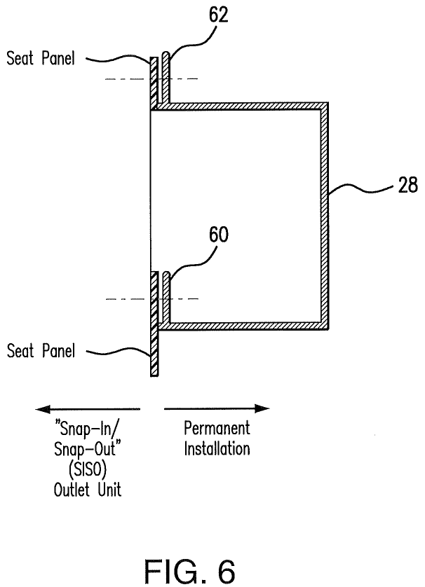

As illustrated in FIG. 6, the OME 28 has the possibility of either internal 60 or external 62 mounting flanges. Each has potential advantages and disadvantages which must be considered. External mounting flanges may facilitate improved electrical bonding for the Faraday cage. Internal mounting flanges may facilitate improved space/volume and faceplate installation. Detailed mechanical design should standardize the best solution. In addition, there is a possibility of flanges on each of the four sides. The number of flanges, on which sides, and whether they are internal or external should be considered as part of this design for a standard OME solution.

Key elements of this concept include:
1. Modularity—standard Modular Outlet Unit (MOU) with Snap-In/Snap-Out (SISO) Outlet Unit features that mate with a standard, fixed installation Outlet Modular Enclosure (OME);
2. Snap-In/Snap-Out (SISO) Outlet Unit feature; and
3. Extension of wire harness shield into a faraday cage enveloping the outlet unit via the OME, and optional conductive faceplate.

Three problems are addressed simultaneously by this design concept:
1. EMI emissions and susceptibility exposure created by outlet unit polymer housing openings, unshielded, pin-to-pin connectors, and inadequate shielding through the connector.
2. Manipulation of outlet unit designs to meet EMI requirements adversely affecting other performance requirements, such as data pass-thru. The outlet units can be largely qualified on their own for environmental and electrical tests, but the EMI testing takes credit for installation which use the OME.
3. Seat Integrators, OEM installers, and aircraft maintenance mechanics have no further need to extract wire harness loops from seats, or to torque clamps when replacing outlet units.

This concept leads to the following advantages:
a. Prior outlet configuration does not need to be tampered with to meet EMI, thus preserving qualification by similarity claims. In the case of EMI testing, the test would then “take credit” for the installation (the OME) in much the same way as cabin power supplies frequently take credit for installation of a “shroud” for waterproofness qualification tests.
   i. Existing thermoplastic molded housings can remain in use
b. The snap-in/snap-out outlet unit design offers a maintenance and installation improvement feature to seat integrators and OEMs. No harness loops are needed, and maintenance time can be reduced.
   i. A “family” of standard MOUs can be offered, utilizing the same OME
c. EMI performance improvements can be leveraged, while simultaneously offering improved ability to meet data pass-thru requirements.
   i. Additional EMI improvements might be realized by implementing an electrically mating conductive faceplate.
d. Helps solve EMI emissions and susceptibility exposure created by outlet unit polymer housing openings, pin and socket connectors, and inadequate shielding through the connector (especially with high speed USB data applications).
e. Seat Integrators, OEM installers, and aircraft maintenance mechanics have no further need to extract wire harness loops from seats, or to torque clamps when replacing outlet units. Snap-In/Snap-Out family of modular OUs offer feature variation to customers (i.e.—Type A, Type C, combination units).
f. Permanently installed OME facilitates a family of compatible SISO OUs.

Implementation details for best solutions may include variations. For example, an electrical bonding method of the cable harness shield to the outlet modular enclosure (OME) is proposed here, but detailed mechanical design may define minor differences in the actual implementation.

I claim:

1. An outlet modular enclosure configured to receive an outlet unit comprising:
an electrically conductive housing having a first aperture sized to receive the outlet unit and a second aperture sized to receive a wire harness;
wherein the electrically conductive housing forms at least a portion of a Faraday cage around the outlet unit.

2. The outlet modular enclosure of claim 1 wherein the electrically conductive housing is configured to be electrically interconnected to an overbraid portion of the wire harness.

3. The outlet modular enclosure of claim 1 having a fixed mating connector disposed therein an adapted to engage a connector portion of the outlet unit.

4. The outlet modular enclosure of claim 1 having a mechanical alignment system adapted to engage an alignment portion of the outlet unit.

5. The outlet modular enclosure of claim 4 wherein the mechanical alignment system is a plurality of cones adapted to engage an alignment pin extending from the outlet unit.

6. The outlet modular unit including a mechanical locking unit to adapted to engage the outlet unit.

7. The outlet modular unit of claim 6 wherein the mechanical locking unit is a plurality of latch flanges adapted to engage a plurality of latches extending from the outlet unit.

8. A power and data assembly comprising:
an outlet modular enclosure configured to receive an outlet unit and a wire harness having an electrically conductive housing with a first aperture sized to receive the outlet unit and a second aperture sized to receive the wire harness, wherein the electrically conductive housing forms at least a portion of a Faraday cage around the outlet unit;
the outlet unit having front side faceplate and opposing rear side wherein the entire outlet unit except for the faceplate is receivable within the first aperture; and
a wire harness adapted to deliver power and data to the outlet unit, the wire harness having an electrically conductive shield overbraid at a first end thereof that is electrically connectable to the outlet modular housing.

9. The assembly of claim 8 wherein the overbraid is mechanically affixed to the outlet modular enclosure.

10. The assembly of claim 9 wherein the overbraid is mechanically affixed to the outlet modular enclosure by an electrically conductive washer and nut assembly.

11. The assembly of claim 9 wherein power and data lines extend from the wire harness and are only exposed within the Faraday cage.

12. The assembly of claim 11 wherein a fixed mating connector within the outlet modular enclosure received the power and data lines.

13. The assembly of claim 12 wherein the fixed mating connector engages with an outlet unit connector.

14. The assembly of claim 11 wherein the faceplate of the outlet unit is electrically conductive and electrically interconnectable to the outlet modular enclosure.

15. The assembly of claim 8 wherein the outlet modular enclosure includes a mechanical locking unit to adapted to engage the outlet unit.

16. The outlet modular unit of claim 15 wherein the mechanical locking unit is a plurality of latch flanges adapted to engage a plurality of latches extending from the outlet unit.

17. The assembly of claim 16 wherein the faceplate includes a plurality of apertures aligned with the plurality of latch flanges to enable engagement by a removal tool.

18. The outlet modular enclosure of claim 8 having a mechanical alignment system adapted to engage an alignment portion of the outlet unit.

19. The outlet modular enclosure of claim 18 wherein the mechanical alignment system is a plurality of cones adapted to engage an alignment pin extending from the outlet unit.

20. The outlet modular enclosure of claim 18 wherein the mechanical alignment system is a groove adapted to engage a rail extending along a side of the outlet unit.
